(19) United States
(12) Patent Application Publication
(10) Pub. No.: US 2025/0016635 A1
(43) Pub. Date: Jan. 9, 2025

(54) RRC SEGMENTATION HANDLING DURING HANDOVER

(71) Applicant: QUALCOMM Incorporated, San Diego, CA (US)

(72) Inventors: Jianhua LIU, Beijing (CN); Xipeng ZHU, San Diego, CA (US); Shankar KRISHNAN, Poway, CA (US); Rajeev KUMAR, San Diego, CA (US); Ozcan OZTURK, San Diego, CA (US); Masato KITAZOE, Tokyo (JP)

(21) Appl. No.: 18/706,536

(22) PCT Filed: Dec. 9, 2022
(86) PCT No.: PCT/CN2022/137787

§ 371 Date: May 1, 2024

(30) Foreign Application Priority Data
Dec. 16, 2021 (WO) PCT/CN2021/138643

(51) Int. Cl. H04W 36/00

(52) U.S. Cl. CPC H04W 36/0072

(57) ABSTRACT

Certain aspects of the present disclosure provide techniques for handling RRC segmentation during a handover procedure. According to certain aspects, a UE may transmit, to a source base station prior to a handover of the UE to a target base station, one or more first segments of a radio resource control (RRC) message; and transmit, to the target base station after the handover, one or more second segments of the RRC message.

### CROSS-REFERENCE TO RELATED APPLICATIONS

This application claims priority to International Patent Application No. PCT/CN2021/138643, filed Dec. 16, 2021, which is assigned to the assignee hereof and hereby expressly incorporated by reference in its entirety as if fully set forth below and for all applicable purposes.

### INTRODUCTION

Aspects of the present disclosure relate to wireless communications, and more particularly, to techniques for handling segmentation of radio resource control (RRC) messages during a handover procedure.

Wireless communication systems are widely deployed to provide various telecommunication services such as telephony, video, data, messaging, broadcasts, or other similar types of services. These wireless communication systems may employ multiple-access technologies capable of supporting communication with multiple users by sharing available system resources with those users (e.g., bandwidth, transmit power, or other resources). Multiple-access technologies can rely on any of code division, time division, frequency division orthogonal frequency division, single-carrier frequency division, or time division synchronous code division, to name a few. These and other multiple access technologies have been adopted in various telecommunication standards to provide a common protocol that enables different wireless devices to communicate on a municipal, national, regional, and even global level.

Although wireless communication systems have made great technological advancements over many years, challenges still exist. For example, complex and dynamic environments can still attenuate or block signals between wireless transmitters and wireless receivers, undermining various established wireless channel measuring and reporting mechanisms, which are used to manage and optimize the use of finite wireless channel resources. Consequently, there exists a need for further improvements in wireless communication networks to overcome various challenges.

### SUMMARY

One aspect provides a method for wireless communications by a user equipment (UE). The method generally includes transmitting, to a source base station prior to a handover of the UE to a target base station, one or more first segments of a radio resource control (RRC) message and transmitting, to the target base station after the handover, one or more second segments of the RRC message.

One aspect provides a method for wireless communications by a source base station. The method generally includes receiving, from a user equipment (UE) prior to a handover of the UE to a target base station, one or more first segments of a radio resource control (RRC) message, transmitting, to the UE, feedback indicating the source base station successfully received one or more of the first segments, and transmitting, to the target base station, one or more of the first segments successfully received by the source base station.

One aspect provides a method for wireless communications by a target base station. The method generally includes message that were successfully received by the source base station from a user equipment (UE) prior to a handover of the UE to the target base station, receiving, from the UE after the handover, one or more second segments of the RRC message, and reassembling the RRC message based on the first segments received from the source base station and the second segments received from the UE.

Other aspects provide: an apparatus operable, configured, or otherwise adapted to perform the aforementioned methods as well as those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF THE DRAWINGS

The appended figures depict certain features of the various aspects described herein and are not to be considered limiting of the scope of this disclosure.

FIG. 1 is a block diagram conceptually illustrating an example wireless communication network.

FIG. 2 is a block diagram conceptually illustrating aspects of an example of a base station and user equipment.

FIG. 3A, FIG. 3B, FIG. 3C, and FIG. 3D depict various example aspects of data structures for a wireless communication network.

FIG. 4 depicts an example of a message that message that may be subject to segmentation.

FIGS. 5-11 depict example techniques for handling RRC segmentation during a handover procedure, in accordance with some aspects of the present disclosure.

FIG. 12 illustrates example operations for wireless communications by a UE, in accordance with some aspects of the present disclosure.

FIG. 13 illustrates example operations for wireless communications by a source base station, in accordance with some aspects of the present disclosure.

FIG. 14 illustrates example operations for wireless communications by a source base station, in accordance with some aspects of the present disclosure.

FIGS. 15-17 depict aspects of example communications devices.

### DETAILED DESCRIPTION

Aspects of the present disclosure provide apparatuses, methods, processing systems, and computer-readable mediums for handling segmentation of radio resource control (RRC) messages during a handover procedure.

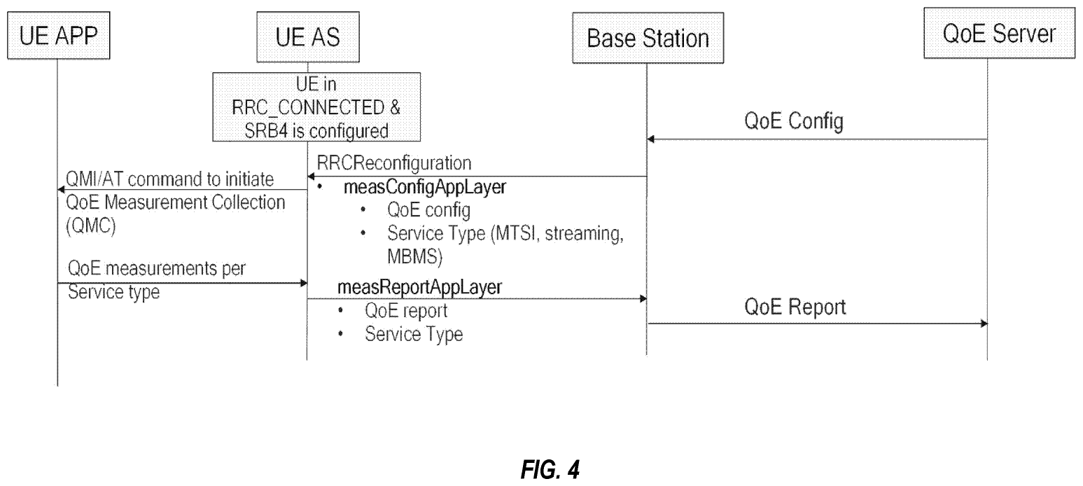

A user equipment (UE) and base station (BS) may exchange information in messages referred to as radio resource control (RRC) messages. One example of such a message is a quality of experience (QoE) report RRC message. As illustrated in FIG. 4, a UE may be configured with a QoE measurement configuration (e.g., using RRCReconfiguration>measConfigAppLayer) and may report QoE measurements using a measReportAppLayer RRC message. If the QoE report message size is larger than a Packet Data Convergence Protocol (PDCP) service data unit (SDU) maximum size, the QoE report message may be segmented.

An RRC message may be segmented in case the size of the encoded RRC message protocol data unit (PDU) exceeds the maximum PDCP SDU size. Segmentation is performed in the RRC layer using a separate RRC PDU to carry each segment. The receiver may reassemble the segments to form a complete RRC message. All segments of an RRC message are transmitted before sending another RRC message. Segmentation is typically supported in both the uplink and downlink. Devices are typically configured to segment the encoded RRC PDU based on the maximum supported size of the PDCP SDU in a manner that minimizes the number of segments.

Unfortunately, in some cases, segmented RRC messages may not be delivered. For example, in current systems, during handover (of a UE from a source base station to a target base station), for signaling radio bearers (SRBs), PDCP SDUs/PDUs are discarded during handover. In such cases, from the UE RRC perspective, the transmission is considered completed in the source cell when it has transmitted all the segments to PDCP layer and, thus, the UE will not retransmit these segments in the target cell. However, in such cases, neither the source cell nor the target cell receives the complete set of segments of a segmented RRC message. As a result, the RRC message will be lost. This issue may exist in a variety of other scenarios (e.g., not just in uplink RRC messages like a QoE report), such as sequence number (SN) change scenarios.

Aspects of the present disclosure, however, provide techniques that may help RRC support segmentation across handovers, without losing a segmented RRC message. In some cases, a target base station may assist by forwarding successfully received RRC segments, while the UE may forward remaining RRC segments. A target base station may be able to reconstruct the complete RRC message from the RRC segments received from the UE and the RRC segments received from the source target base station. As a result, RRC messages (such as a QoE report message), may be sent across handovers, which may avoid the corresponding delays associated with RRC message retransmission.

Those skilled in the art will appreciate that a QoE report RRC message is just one example of an RRC message that may be segmented and for which the techniques described herein may be applied to handle segmentation during handover. The techniques described herein may be applied to RRC messages carrying different types of data in a variety of different scenarios, including positioning data, artificial intelligence (AI)/machine learning (ML) data, non-access stratum (NAS) protocol data units (PDUs), and the like.

### Introduction to Wireless Communication Networks

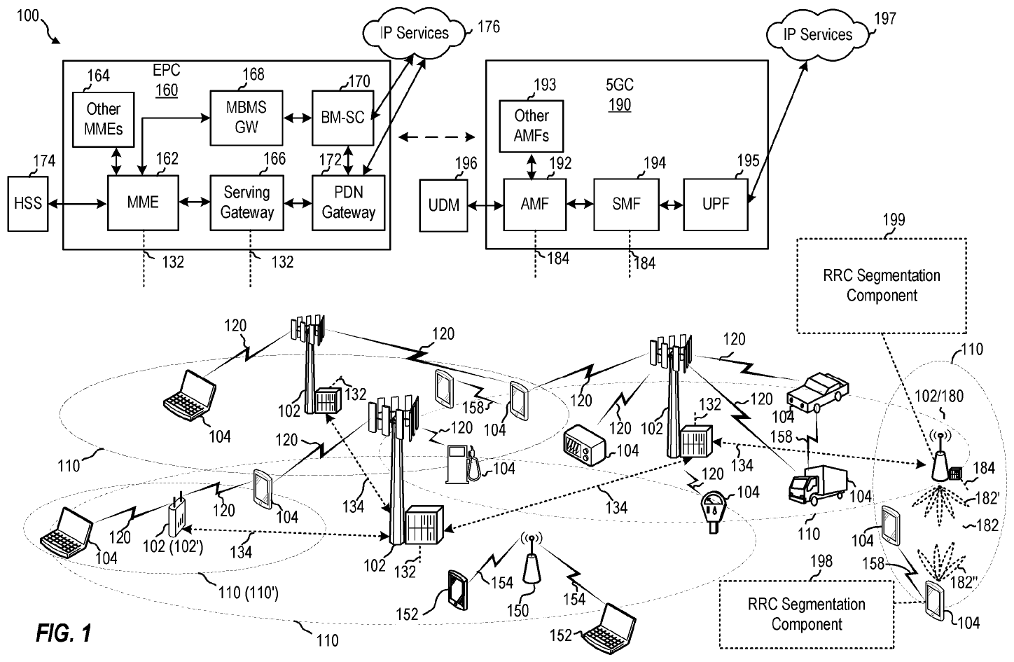

FIG. 1 depicts an example of a wireless communication network 100, in which aspects described herein may be implemented.

Generally, wireless communication network 100 includes base stations (BSs) 102, user equipments (UEs) 104, one or more core networks, such as an Evolved Packet Core (EPC) 160 and 5G Core (5GC) network 190, which interoperate to provide wireless communications services.

Base stations 102 may provide an access point to the EPC 160 and/or 5GC 190 for a user equipment 104, and may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, delivery of warning messages, among other functions. Base stations may include and/or be referred to as a gNB, NodeB, eNB, ng-eNB (e.g., an eNB that has been enhanced to provide connection to both EPC 160 and 5GC 190), an access point, a base transceiver station, a radio base station, a radio transceiver, or a transceiver function, or a transmission reception point in various contexts.

Base stations 102 wirelessly communicate with UEs 104 via communications links 120. Each of base stations 102 may provide communication coverage for a respective geographic coverage area 110, which may overlap in some cases. For example, small cell 102′ (e.g., a low-power base station) may have a coverage area 110′ that overlaps the coverage area 110 of one or more macrocells (e.g., high-power base stations).

The communication links 120 between base stations 102 and UEs 104 may include uplink (UL) (also referred to as reverse link) transmissions from a user equipment 104 to a base station 102 and/or downlink (DL) (also referred to as forward link) transmissions from a base station 102 to a user equipment 104. The communication links 120 may use multiple-input and multiple-output (MIMO) antenna technology, including spatial multiplexing, beamforming, and/or transmit diversity in various aspects.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player, a camera, a game console, a tablet, a smart device, a wearable device, a vehicle, an electric meter, a gas pump, a large or small kitchen appliance, a healthcare device, an implant, a sensor/actuator, a display, or other similar devices. Some of UEs 104 may be internet of things (IoT) devices (e.g., parking meter, gas pump, toaster, vehicles, heart monitor, or other IoT devices), always on (AON) devices, or edge processing devices. UEs 104 may also be referred to more generally as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, or a client.

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, base station 180 and the UE 104 may each include a plurality of antennas, such as antenna elements, antenna panels, and/or antenna arrays to facilitate the beamforming.

In some cases, base station 180 may transmit a beamformed signal to UE 104 in one or more transmit directions 182′. UE 104 may receive the beamformed signal from the base station 180 in one or more receive directions 182″. UE 104 may also transmit a beamformed signal to the base station 180 in one or more transmit directions 182″. Base station 180 may also receive the beamformed signal from UE 104 in one or more receive directions 182′. Base station 180 and UE 104 may then perform beam training to determine the best receive and transmit directions for each of base station 180 and UE 104. Notably, the transmit and receive directions for base station 180 may or may not be the same. Similarly, the transmit and receive directions for UE 104 may or may not be the same.

Wireless communication network 100 includes RRC Segmentation Component 199, which may be configured to receive and process RRC messages sent via segmentation (e.g., from UE 104). Wireless network 100 further includes RRC Segmentation Component 198, which may be used generate and transmit segmented RRC messages.

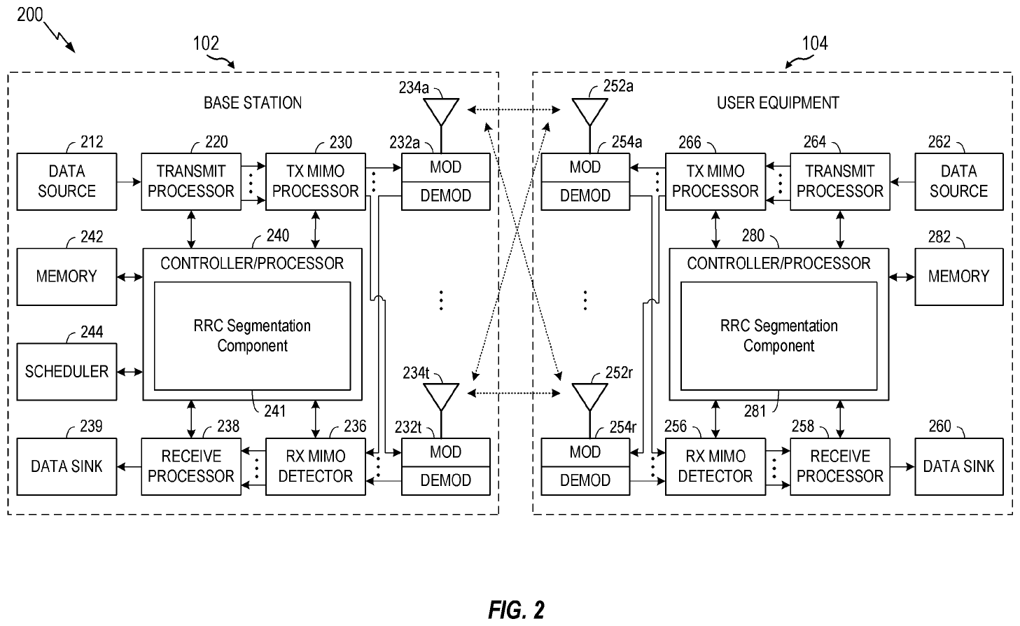

FIG. 2 depicts aspects of an example base station (BS) 102 and a user equipment (UE) 104.

Generally, base station 102 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, base station 102 may send and receive data between itself and user equipment 104.

Base station 102 includes controller/processor 240, which may be configured to implement various functions related to wireless communications. In the depicted example, controller/processor 240 includes RRC Segmentation component 241, which may be representative of RRC Segmentation component 199 of FIG. 1. Notably, while depicted as an aspect of controller/processor 240, RRC Segmentation component 241 may be implemented additionally or alternatively in various other aspects of base station 102 in other implementations.

Generally, user equipment 104 includes various processors (e.g., 258, 264, 266, and 280), antennas 252a-r (collectively 252), transceivers 254a-r (collectively 254), which include modulators and demodulators, and other aspects, which enable wireless transmission of data (e.g., data source 262) and wireless reception of data (e.g., data sink 260).

User equipment 104 includes controller/processor 280, which may be configured to implement various functions related to wireless communications. In the depicted example, controller/processor 280 includes RRC Segmentation component 281, which may be representative of RRC Segmentation component 198 of FIG. 1. Notably, while depicted as an aspect of controller/processor 280, RRC Segmentation component 281 may be implemented additionally or alternatively in various other aspects of user equipment 104 in other implementations.

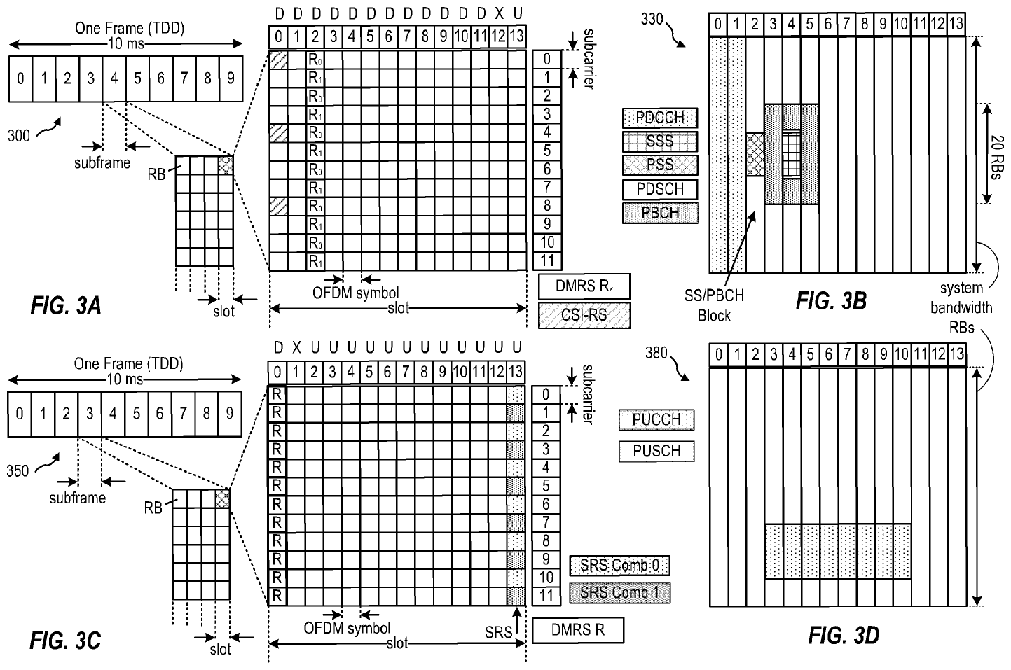

FIGS. 3A-3D depict aspects of data structures for a wireless communication network, such as wireless communication network 100 of FIG. 1. In particular, FIG. 3A is a diagram 300 illustrating an example of a first subframe within a 5G (e.g., 5G NR) frame structure, FIG. 3B is a diagram 330 illustrating an example of DL channels within a 5G subframe, FIG. 3C is a diagram 350 illustrating an example of a second subframe within a 5G frame structure, and FIG. 3D is a diagram 380 illustrating an example of UL channels within a 5G subframe.

Further discussions regarding FIG. 1, FIG. 2, and FIGS. 3A-3D are provided later in this disclosure.

### Introduction to mmWave Wireless Communications

In wireless communications, an electromagnetic spectrum is often subdivided into various classes, bands, channels, or other features. The subdivision is often provided based on wavelength and frequency, where frequency may also be referred to as a carrier, a subcarrier, a frequency channel, a tone, or a subband.

5G networks may utilize several frequency ranges, which in some cases are defined by a standard, such as the 3GPP standards. For example, 3GPP technical standard TS 38.101 currently defines Frequency Range 1 (FR1) as including 600 MHZ-6 GHZ, though specific uplink and downlink allocations may fall outside of this general range. Thus, FR1 is often referred to (interchangeably) as a “Sub-6 GHz” band.

Similarly, TS 38.101 currently defines Frequency Range 2 (FR2) as including 26-41 GHz, though again specific uplink and downlink allocations may fall outside of this general range. FR2, is sometimes referred to (interchangeably) as a “millimeter wave” (“mmW” or “mmWave”) band, despite being different from the extremely high frequency (EHF) band (30 GHz-300 GHz) that is identified by the International Telecommunications Union (ITU) as a “millimeter wave” band because wavelengths at these frequencies are between 1 millimeter and 10 millimeters.

Communications using mmWave/near mm Wave radio frequency band (e.g., 3 GHZ-300 GHz) may have higher path loss and a shorter range compared to lower frequency communications. As described above with respect to FIG. 1, a base station (e.g., 180) configured to communicate using mmWave/near mmWave radio frequency bands may utilize beamforming (e.g., 182) with a UE (e.g., 104) to improve path loss and range.

In order to support 5G existing services (e.g. streaming services) and new emerging services in the future, potential mechanisms to support various aspects have been explored in NR. One example is the potential RAN side solution for supporting a generic framework for triggering, configuring, measurement collection and reporting for various 5G use cases. For example, potential solutions may be explored (e.g., LTE based solution, reusing MDT mechanism) for configuration and reporting of UE Key Performance Indicators (KPI) information for certain services (e.g., latency). The potential interface impact and solutions of various interfaces (e.g., F1, NG, Xn interface) to support NR QoE functionality may also be explored. As noted above, QoE report message may be segmented if they exceed a maximum PDCP SDU size.

### Overview of RRC Segmentation

As noted above, an RRC message may be segmented in case the size of the encoded RRC message PDU exceeds the maximum PDCP SDU size. Segmentation is performed in the RRC layer using a separate RRC PDU to carry each segment. The receiver reassembles the segments to form the complete RRC message. Typically, all segments of an RRC message are transmitted before sending another RRC message. Segmentation is supported in both uplink and downlink.

For uplink, a UE typically follows a procedure for segmenting the encoded RRC PDU based on the maximum supported size of a PDCP SDU (e.g., as specified in a wireless communications standard), designed to minimize the number of segments and set the contents of the ULDedicatedMessageSegment messages. For each new uplink (UL) dedicated control channel (DCCH) message, set the segmentNumber to 0 for the first message segment and increment the segmentNumber for each subsequent RRC message segment. The UE then sets rrc-MessageSegmentContainer to include the segment of the UL DCCH message corresponding to the segmentNumber. If the segment included in the rrc-MessageSegmentContainer is the last segment of the UL DCCH message, then the UE sets the rrc-MessageSegmentType to lastSegment; otherwise, the UE sets the rrc-Message SegmentType to notLastSegment. The UE then submits all the ULDedicatedMessageSegment messages generated for the segmented RRC message to lower layers for transmission in ascending order based on the segmentNumber, upon which the procedure ends.

### Overview of Lossless Handover for Uplink

In current systems, it is desirable for a UE to be able to handover (HO) from a source base station (e.g., a source gNB or S-gNB) to a target base station (e.g., a target gNB or T-gNB) in a manner that achieves little or no loss of UL data. One approach to achieve this is as follows.

As long as data forwarding of UL user data packets takes place for dedicated radio bearers (DRBs) for which preservation of sequence number (SN) status applies the source NG-RAN node (S-gNB) either: discards the uplink PDCP PDUs received out of sequence if the source NG-RAN node has not accepted the request from the target NG-RAN node for uplink forwarding or if the target NG-RAN node has not requested uplink forwarding for the bearer during the Handover Preparation procedure; or forwards to the target NG-RAN node via the corresponding DRB UL forwarding tunnel, the uplink PDCP SDUs with their SN corresponding to PDCP PDUs received out of sequence if the source NG-RAN node has accepted the request from the target NG-RAN node for uplink forwarding for the bearer during the Handover Preparation procedure, including PDCP SDUs corresponding to user data of those QoS flows, for which re-mapping happened for a QoS flow before the handover and the SDAP end marker has not yet been received at the source NG-RAN node.

As long as data forwarding of UL user data packets takes place for a PDU session, the source NG-RAN node forwards via the corresponding PDU session UL forwarding tunnel, the uplink SDAP SDUs corresponding to QoS flows for which flow re-mapping happened before the handover and the SDAP end marker has not yet been received at the source NG-RAN node, and which were received at the source NG-RAN node via the DRB to which the QoS flow was remapped.

PDCP entity handling for AM DRBs when RRC re-establishment is typically as follows. For acknowledgment mode (AM) DRBs whose PDCP entities were not suspended, from the first PDCP SDU for which the successful delivery of the corresponding PDCP Data PDU has not been confirmed by lower layers, perform retransmission or transmission of all the PDCP SDUs already associated with PDCP SNs in ascending order of the COUNT values associated to the PDCP SDU prior to the PDCP entity re-establishment as follows. The entity may perform header compression of the PDCP SDU (e.g., using robust header compression—ROHC), integrity protection and ciphering of the PDCP SDU (e.g., using a COUNT value associated with this PDCP SDU, and submit the resulting PDCP Data PDU to a lower layer.

Unfortunately, with current mechanisms, during handover, for SRBs all PDCP SDUs/PDUs are discarded. This means from the UE RRC perspective, the transmission is completed in the source cell when it has transmitted all the segments to PDCP layer. As a result, the UE RRC will not be retransmitting the segments in the target cell. However, in such cases, neither source cell nor target cell receives complete segments. So if the UE cannot successfully transmit all the segments to the source gNB, the RRC message will be lost. Similar issues may exist in various other scenarios, such as sequence number (SN) change scenarios.

### Aspects Related to Handling RRC Segments During Handover

Aspects of the present disclosure, however, provide techniques that may help RRC support segmentation across handovers, without losing a segmented RRC message. In some cases, a target base station may assist by forwarding successfully received RRC segments, while the UE may forward remaining RRC segments. A target base station may be able to reconstruct the complete RRC message from the RRC segments received from the UE and the RRC segments received from the source target base station. As a result, segmented RRC messages, may be successfully sent across handovers, which may avoid the corresponding delays associated with RRC message retransmission.

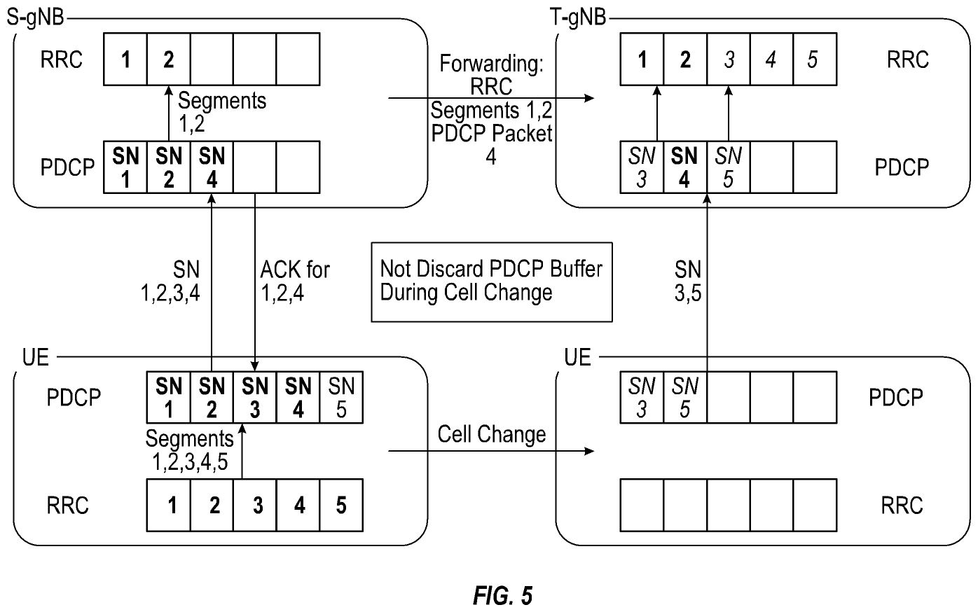

According to certain aspects of the present disclosure, a PDCP layer may perform retransmission or transmission (to the T-gNB) of all the PDCP SDUs unsuccessfully transmitted or non-transmitted (to the S-gNB). In addition, further enhancements are proposed with an S-gNB forwarding received RRC segments to the T-gNB. The S-gNB may also forward all received PDCP SDUs (including in-order and out-order) to T-gNB. In some cases, the UE retransmits all the PDCP SDUs associated with all the RRC segments for one RRC message. The T-gNB may then (re-) assemble the RRC message according to the RRC segments received from the UE (and S-gNB). Details of these mechanisms are described below (e.g., with reference to FIGS. 5-8).

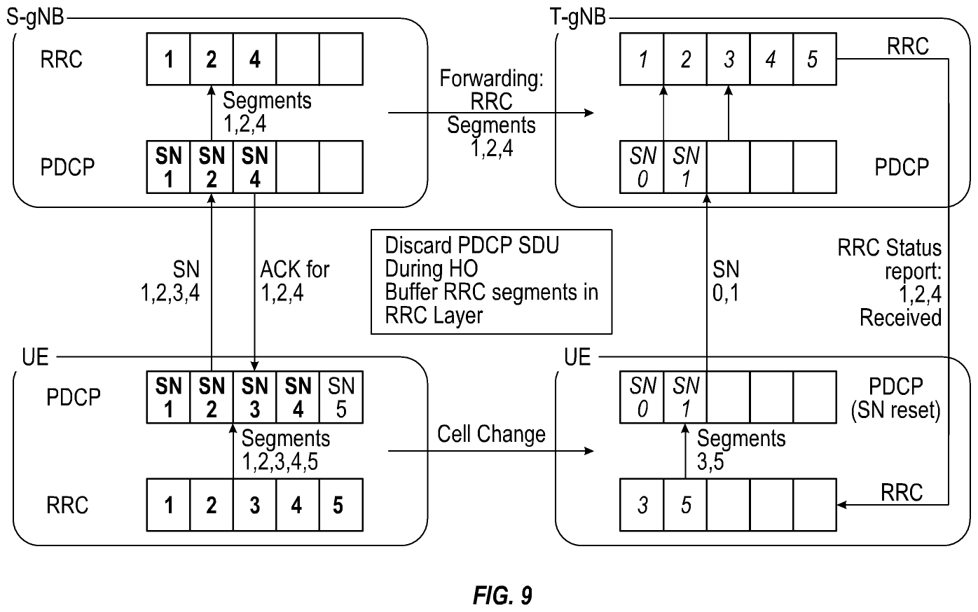

According to certain aspects of the present disclosure, in some cases, a UE PDCP entity may discard all the data for the SRB. In such cases, the UE may rely on the RRC layer to retransmit or transmit the RRC segments. The T-gNB may then (re-) assemble the RRC message according to the RRC segments received from the UE. Details of these mechanisms are described below (e.g., with reference to FIGS. 9-11).

FIG. 5 illustrates a first example mechanism where the PDCP buffer contents are not discarded during HO. As illustrated, at the S-gNB, the PDCP layer delivers received SDUs to the RRC layer in order. In this case, the S-gNB forwards the (successfully) received RRC segments and PDCP SDU to the T-gNB.

In the illustrated example, one RRC message is segmented into RRC segments 1,2,3,4,5. The UE, thus, has PDCP SDUs 1,2,3,4,5 to be transmitted. Such SDUs carry RRC segments for one RRC message. In this example, the UE PDCP layer sends 1,2,3,4 to S-gNB, and S-gNB provides ACK for 1,2,4 (e.g., PDCP SDU 3 is not successfully received by the s-gNB).

In this cases, the S-gNB PDCP layer delivers in-order segments 1,2 to the s-gNB RRC layer (but not out-of-order segment 4). During HO, the S-gNB forwards RRC layer segments and PDCP SDUs (for segment 4) to the T-gNB.

After HO, the UE PDCP layer (re)-transmits the remaining PDCP SDUs 3,5 (that were not successfully received by the S-gNB) to the T-gNB, and the T-gNB PDCP layer delivers segments 3,4,5 to the RRC layer.

This approach may, thus, help achieve lossless RRC segments during cell change. This may be accomplished by applying lossless PDCP data handling mechanism to SRB. The S-gNB may be configured to forward received RRC segments to T-gNB, while the T-gNB is configured to reassemble RRC message based on segments received from the S-gNB and PDCP layer.

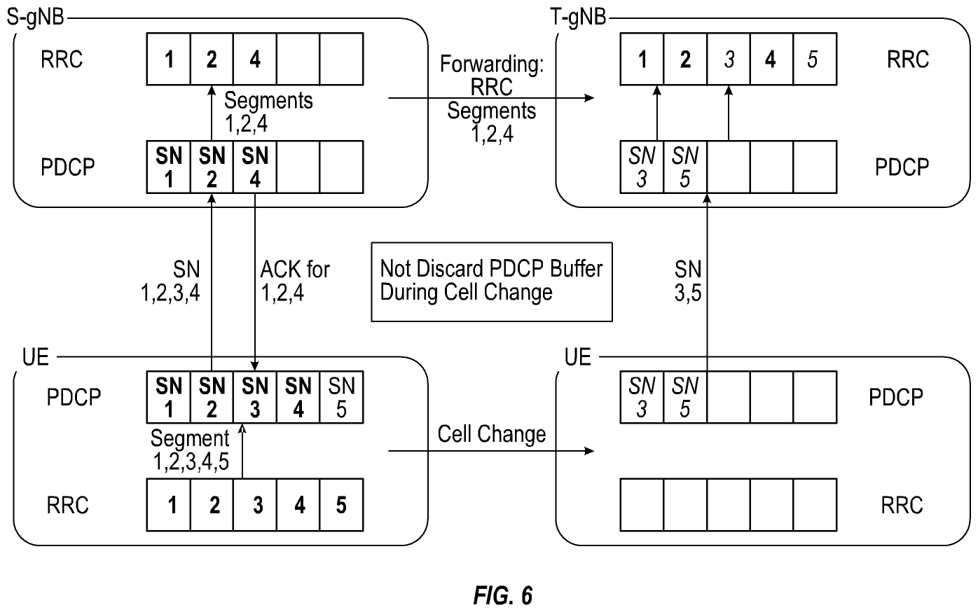

FIG. 6 illustrates a second example mechanism where PDCP buffer contents are not discarded during HO. As illustrated, in this example, the S-gNB PDCP layer delivers to the RRC layer all of the received SDUs (in-order and out-of-order) and the S-gNB forwards the received RRC segments to the T-gNB.

As with the example of FIG. 5, the example of FIG. 6 assumes one RRC message is segmented into RRC segments 1,2,3,4,5, that the UE PDCP layer sends 1,2,3,4 to S-gNB, and that the S-gNB again provides ACK for 1,2,4 (or NACK for 3).

In this case, the S-gNB PDCP layer delivers both in-order segments 1,2 and out-of-order segment 4 to the RRC layer. During cell change, the S-gNB forwards RRC layer segments 1,2,4 to the T-gNB. After the cell change, the UE PDCP layer (re)-transmits PDCP SDU 3, 5 to the T-gNB, and T-gNB PDCP delivers SDU 3,5 to RRC layer. The T-gNB then reassembles the RRC message based on the RRC segments from the S-gNB and the RRC segments from the UE.

This approach may also help achieve lossless RRC segments during cell change. This may be accomplished by applying lossless PDCP data handling mechanisms to SRB. The S-gNB may be configured to forward received RRC segments to T-gNB, but in this case, the S-gNB PDCP does not reorder and the S-gNB does not forward PDCP SDU(s) to the T-gNB. The T-gNB reassembles the RRC message based on segments received from S-gNB and UE.

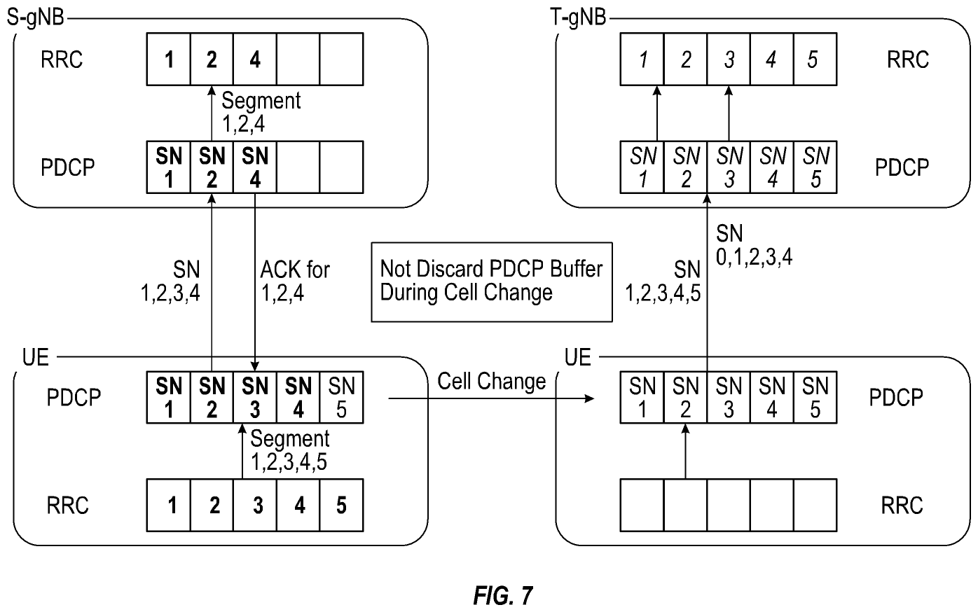

FIG. 7 illustrates a third example mechanism where PDCP buffer contents are not discarded during HO. In this case, the S-gNB does not forward any data to the T-gNB. Rather, the UE will retransmit all the RRC segments to the T-gNB.

As with the examples above, the example of FIG. 7 assumes one RRC message is segmented into RRC segments 1,2,3,4,5, that the UE PDCP layer sends 1,2,3,4 to S-gNB, and that the S-gNB again provides ACK for 1,2,4.

In this case, the S-gNB PDCP layer delivers both in-order segments 1,2 and out-of-order segment 4 to the RRC layer but, during cell change, the S-gNB does not forward RRC layer segments 1,2,4 to the T-gNB. Rather, after the cell change, the UE PDCP layer UE PDCP layer (re)-transmits all the PDCP SDUs associated with segments 1,2,3,4,5 to the T-gNB, Thus, in this case, the S-gNB RRC layer discards 1,2,4 segments.

This approach may also help achieve lossless RRC segments during cell change, albeit with some cost in duplicated PDCP SDU transmission. In this case, the S-gNB discards RRC segments if it cannot reassemble onto one RRC message. The UE PDCP layer does not discard the associated SDUs for the RRC message if there is any segment transmitted unsuccessfully, and the UE PDCP layer will retransmit all the buffered SDUs for RRC segments to T-gNB.

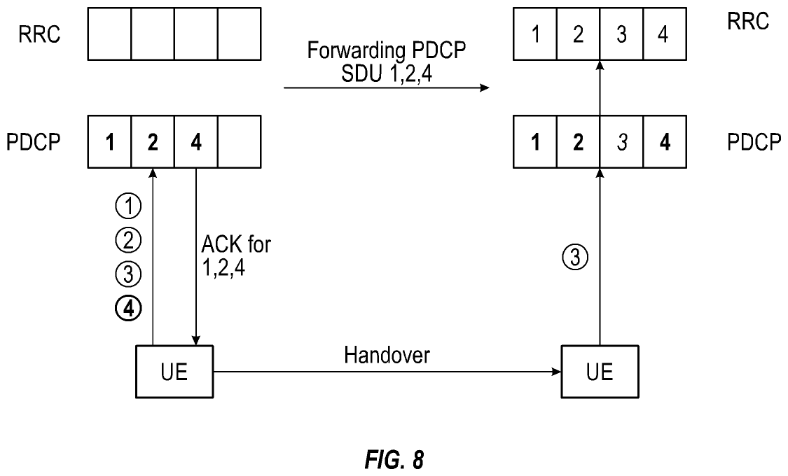

FIG. 8 illustrates a fourth example mechanism where the s-gNB does not deliver SDUs to the RRC layer unless it receives all RRC segments.

As with the examples above, the example of FIG. 8 assumes one RRC message is segmented into RRC segments 1,2,3,4,5, that the UE PDCP layer sends 1,2,3,4 to S-gNB, and that the S-gNB again provides ACK for 1,2,4. In this case, however, when the UE PDCP layer sends SDU 1,2,3,4 (SN 1,2,3,4) to the S-gNB, it also sends an indication that 4 is the last segment for the RRC message. Based on this indication, when the S-gNB PDCP layer receives SN 1,2,4, it realizes SN 3 is missing and does not forward these packets (SN 1, 2, 4) to the RRC layer.

As illustrated, in this case, the S-gNB forwards PDCP SDU 1,2,4 to T-gNB, with an indication that 4 is the last segment for one RRC message. The UE PDCP layer retransmits (the missing) SDU 3 to the T-gNB. The T-gNB PDCP layer then sends all of the SDU 1,2,3,4 to RRC the layer.

This approach may also help achieve lossless RRC segments during cell change. In this case, the UE PDCP layer indicates to the S-gNB the last segment for one RRC message (e.g. indicates which SN is the last segment). The gNB PDCP layer does not deliver to the RRC layer the in-order SDUs unless it receives all segments with the last segment SN indication.

FIG. 9 illustrates a fifth example mechanism where the PDCP buffer contents are discarded during HO. As illustrated, the S-gNB forwards received RRC segments to the T-gNB and the T-gNB sends an RRC layer status report to the UE RRC layer.

As with the examples above, the example of FIG. 9 assumes one RRC message is segmented into RRC segments 1,2,3,4,5, that the UE PDCP layer sends 1,2,3,4 to S-gNB, and that the S-gNB again provides ACK for 1,2,4. The S-gNB forwards the received RRC segments 1,2,4, to the T-gNB.

In this case, however, the UE discards the PDCP buffer. Rather, after cell change, T-gNB sends RRC status report to UE RRC layer, indicating RRC segments 1,2,4 are received. In response, the UE RRC layer (re)-transmits the segments 3,5 to T-gNB (and S-gNB RRC layer discards 1,2,4 segments).

This approach may also help achieve lossless RRC segments during cell change, albeit with duplicated RRC segments transmission. In this case, the S-gNB forwards received RRC segments to T-gNB, but the S-gNB PDCP does not reorder and the S-gNB does not forward PDCP SDU to T-gNB. The T-gNB sends an RRC message to the UE indicating received RRC segments, the UE RRC layer (re) transmits the unsuccessfully transmitted RRC segments to the target gNB, and the T-gNB reassembles RRC message based on the RRC segments received from S-gNB and UE.

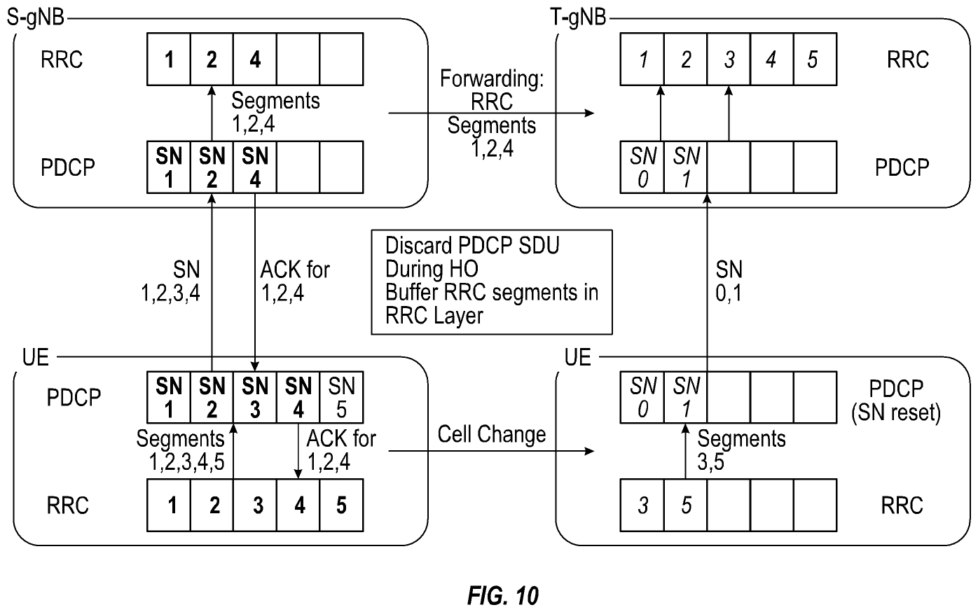

FIG. 10 illustrates a sixth example mechanism where the PDCP buffer contents are discarded during HO. As illustrated, the S-gNB forwards received RRC segments to the T-gNB. In this case, the UE PDCP layer indicates, to the RRC layer, the received RRC segment number.

As with the examples above, the example of FIG. 10 assumes one RRC message is segmented into RRC segments 1,2,3,4,5, that the UE PDCP layer sends 1,2,3,4 to S-gNB, and that the S-gNB again provides ACK for 1,2,4. The S-gNB forwards the received RRC segments 1,2,4, to the T-gNB.

In this case, after cell change, the UE RRC layer (re)-transmits RRC segments 3,5 to T-gNB. As illustrated, a PDCP SN reset may occur, however, such that RRC segments 3,5 are sent with PDCP SN 0,1. The gNB reassembles the RRC message based on the RRC segments from S-gNB and PDCP layer.

This approach may also help achieve lossless RRC segments during cell change. In this case, the S-gNB forwards received RRC segments to T-gNB, but the S-gNB PDCP does not reorder and the S-gNB does not forward PDCP SDU to T-gNB. In this case, the UE PDCP layer indicates to the UE RRC layer successful delivery of RRC segments. Based on this indication, the UE RRC layer (re) transmits the unsuccessfully transmitted RRC segments to the target gNB. The T-gNB reassembles RRC message based on segments received from S-gNB and UE.

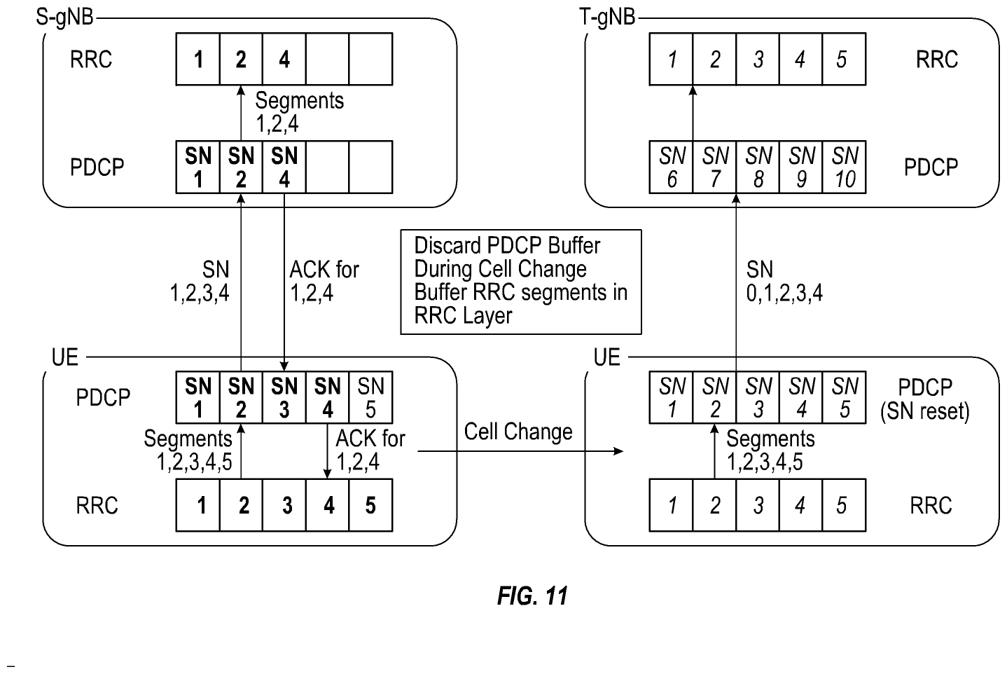

FIG. 11 illustrates a seventh example mechanism where the PDCP buffer contents are discarded during HO. In this case, the S-gNB does not forward any date to the T-gNB. Rather, in this case, the UE will retransmit all the RRC segments to the T-gNB.

As with the examples above, the example of FIG. 11 assumes one RRC message is segmented into RRC segments 1,2,3,4,5, that the UE PDCP layer sends 1,2,3,4 to S-gNB, and that the S-gNB again provides ACK for 1,2,4.

In this example, the S-gNB PDCP layer delivers segments 1,2,4 to the S-gNB RRC layer. After cell change, the UE RRC layer (re)-transmits all the segments 1,2,3,4,5 to T-gNB. Thus, the S-gNB RRC layer can discard segments 1,2,4.

This approach may also help achieve lossless RRC segments during cell change with duplicated RRC segments transmission. In this case, the S-gNB may be configured to discard RRC segments if it cannot reassemble the RRC segments into one RRC message. The UE PDCP layer indicates, to the UE RRC layer, successful delivery of RRC segments. If any of the RRC segments were not successfully delivered, the UE RRC layer (re) transmits all RRC segments to the target gNB.

### Example Operations

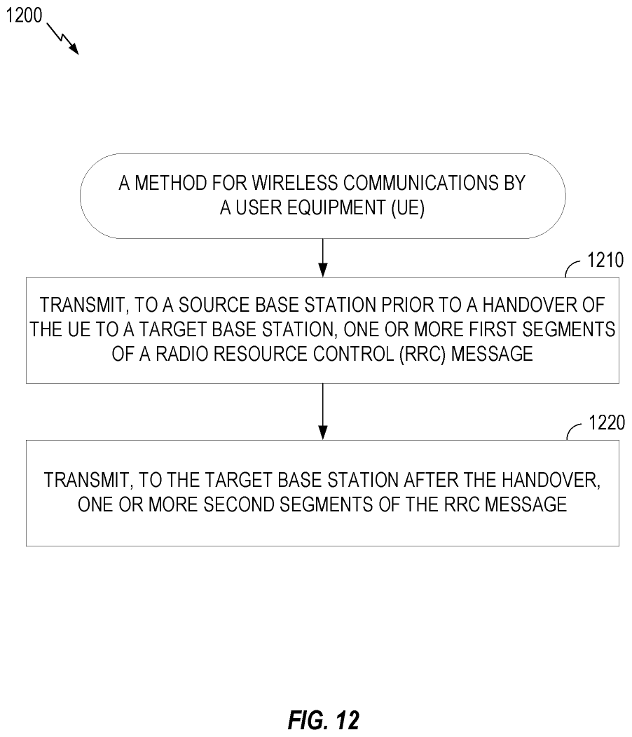

FIG. 12 illustrates example operations 1200 for wireless communication by a UE. The operations 1200 may be performed, for example, by a UE (e.g., such as a UE 104 of FIG. 1) to transmit a segmented RRC message, in accordance with aspects of the present disclosure.

At 1210, the UE transmits, to a source base station prior to a handover of the UE to a target base station, one or more first segments of a radio resource control (RRC) message.

At 1220, the UE transmits, to the target base station after the handover, one or more second segments of the RRC message.

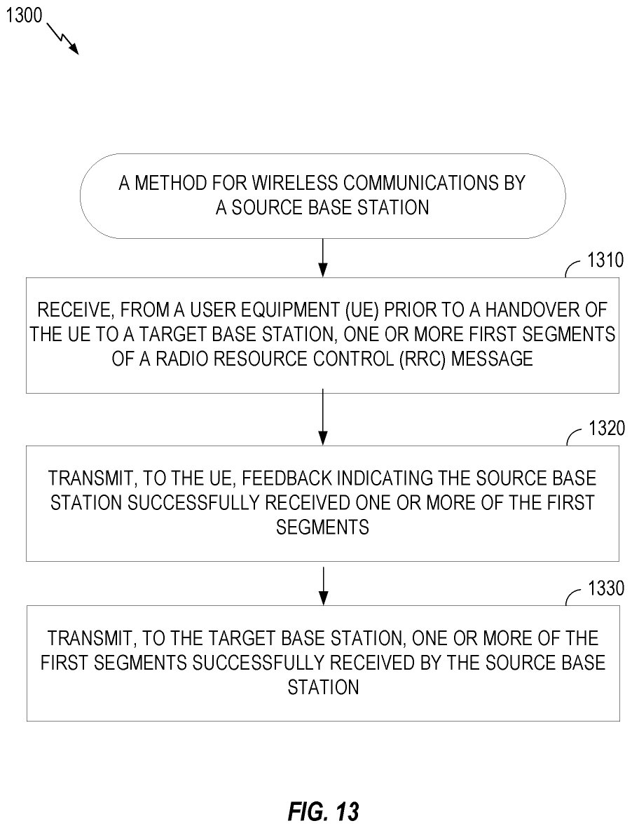

FIG. 13 illustrates example operations 1300 for wireless communication by a source base station. The operations 1300 may be performed, for example, by a source base station (e.g., BS 102 of FIG. 1) to help deliver a segmented RRC message from a UE (e.g., from a UE performing operations 1200 of FIG. 12).

At 1310, the source base station receives, from a user equipment (UE) prior to a handover of the UE to a target base station, one or more first segments of a radio resource control (RRC) message.

At 1320, the source base station transmits, to the UE, feedback indicating the source base station successfully received one or more of the first segments.

At 1330, the source base station transmits, to the target base station, one or more of the first segments successfully received by the source base station.

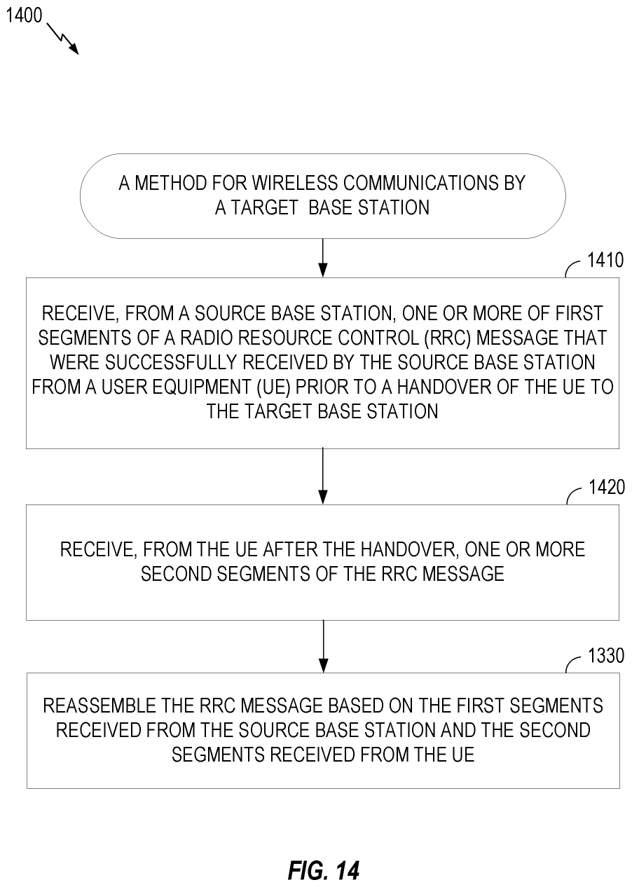

FIG. 14 illustrates example operations 1400 for wireless communication by a target base station. The operations 1400 may be performed, for example, by a target base station (e.g., BS 102 of FIG. 1) to reassemble an RRC message from a UE (e.g., from a UE performing operations 1200 of FIG. 12) based on RRC segments received from the UE and from a source base station.

At 1410, the target base station receives, from a source base station, one or more of first segments of a radio resource control (RRC) message that were successfully received by the source base station from a user equipment (UE) prior to a handover of the UE to the target base station.

At 1420, the target base station receives, from the UE after the handover, one or more second segments of the RRC message.

At 1430, the target base station reassembles the RRC message based on the first segments received from the source base station and the second segments received from the UE.

### Example Wireless Communication Devices

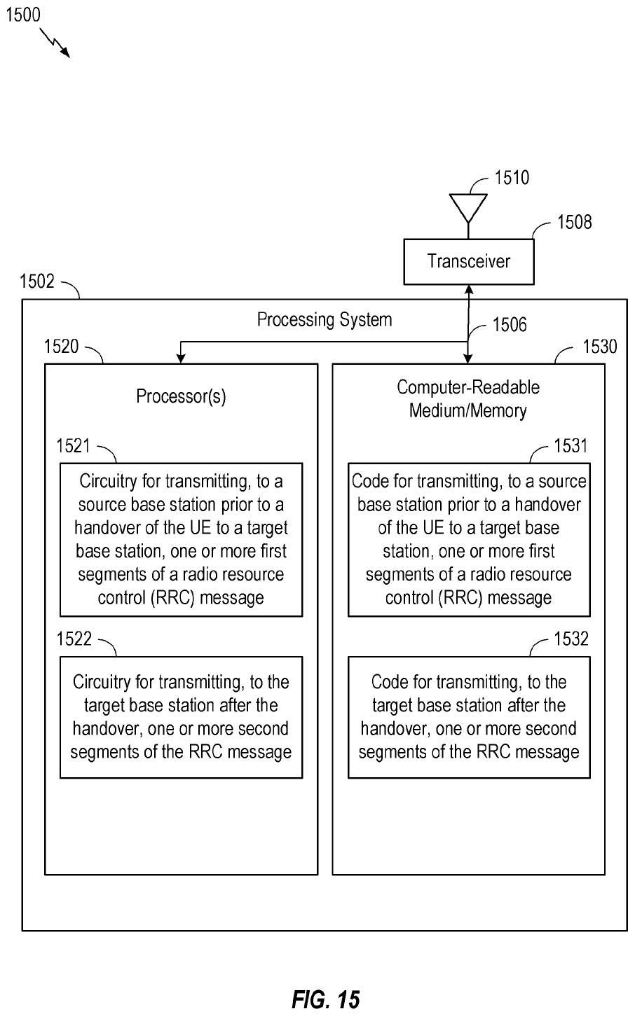

FIG. 15 depicts an example communications device 800 that includes various components operable, configured, or adapted to perform operations for the techniques disclosed herein, such as the operations depicted and described with respect to FIG. 12. In some examples, communication device 1500 may be a user equipment 104 as described, for example with respect to FIGS. 1 and 2.

Communications device 1500 includes a processing system 1502 coupled to a transceiver 1508 (e.g., a transmitter and/or a receiver). Transceiver 1508 is configured to transmit (or send) and receive signals for the communications device 1500 via an antenna 1510, such as the various signals as described herein. Processing system 1502 may be configured to perform processing functions for communications device 1500, including processing signals received and/or to be transmitted by communications device 1500.

Processing system 1502 includes one or more processors 1520 coupled to a computer-readable medium/memory 1530 via a bus 1506. In certain aspects, computer-readable medium/memory 1530 is configured to store instructions (e.g., computer-executable code) that when executed by the one or more processors 1520, cause the one or more processors 1520 to perform the operations illustrated in FIG. 12, or other operations for performing the various techniques discussed herein.

In the depicted example, computer-readable medium/memory 1530 stores code 1531 for transmitting, to a source base station prior to a handover of the UE to a target base station, one or more first segments of a radio resource control (RRC) message and code 1532 for transmitting, to the target base station after the handover, one or more second segments of the RRC message.

In the depicted example, the one or more processors 1520 include circuitry configured to implement the code stored in the computer-readable medium/memory 1530, including circuitry 1521 for transmitting, to a source base station prior to a handover of the UE to a target base station, one or more first segments of a radio resource control (RRC) message and circuitry 1523 for transmitting, to the target base station after the handover, one or more second segments of the RRC message.

Various components of communications device 1500 may provide means for performing the methods described herein, including with respect to FIG. 12.

In some examples, means for transmitting or sending (or means for outputting for transmission) may include the transceivers 254 and/or antenna(s) 252 of the user equipment 104 illustrated in FIG. 2 and/or transceiver 1508 and antenna 1510 of the communication device 1500 in FIG. 15.

In some examples, means for receiving (or means for obtaining) may include the transceivers 254 and/or antenna(s) 252 of the user equipment 104 illustrated in FIG. 2 and/or transceiver 1508 and antenna 1510 of the communication device 1500 in FIG. 15.

In some examples, means for generating and/or transmitting may include various processing system components, such as: the one or more processors 1520 in FIG. 15, or aspects of the user equipment 104 depicted in FIG. 2, including receive processor 258, transmit processor 264, TX MIMO processor 266, and/or controller/processor 280 (including RRC Segmentation component 281).

Notably, FIG. 15 is an example, and many other examples and configurations of communication device 1500 are possible.

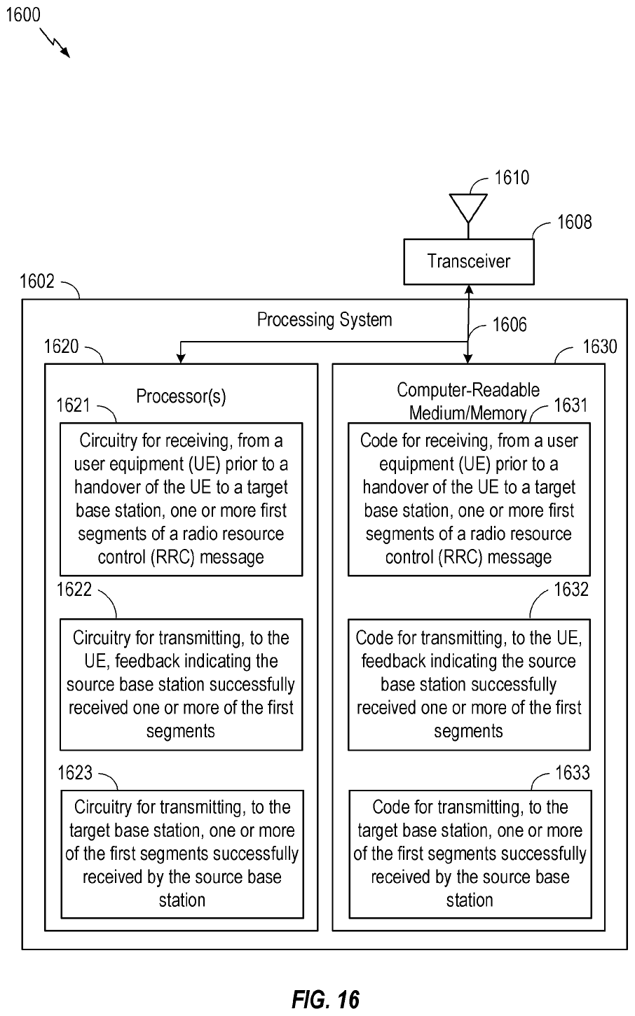

FIG. 16 depicts an example communications device 1600 that includes various components operable, configured, or adapted to perform operations for the techniques disclosed herein, such as the operations depicted and described with respect to FIG. 13. In some examples, communication device 1600 may be a base station 102 as described, for example with respect to FIGS. 1 and 2.

Communications device 1600 includes a processing system 1602 coupled to a transceiver 1608 (e.g., a transmitter and/or a receiver). Transceiver 1608 is configured to transmit (or send) and receive signals for the communications device 1600 via an antenna 1610, such as the various signals as described herein. Processing system 1602 may be configured to perform processing functions for communications device 1600, including processing signals received and/or to be transmitted by communications device 1600.

Processing system 1602 includes one or more processors 1620 coupled to a computer-readable medium/memory 1630 via a bus 1606. In certain aspects, computer-readable medium/memory 1630 is configured to store instructions (e.g., computer-executable code) that when executed by the one or more processors 1620, cause the one or more processors 1620 to perform the operations illustrated in FIG. 13, or other operations for performing the various techniques discussed herein.

In the depicted example, computer-readable medium/memory 1630 stores code 1631 for receiving, from a user equipment (UE) prior to a handover of the UE to a target base station, one or more first segments of a radio resource control (RRC) message, code 1632 for transmitting, to the UE, feedback indicating the source base station successfully received one or more of the first segments, and code 1633 for transmitting, to the target base station, one or more of the first segments successfully received by the source base station.

In the depicted example, the one or more processors 1620 include circuitry configured to implement the code stored in the computer-readable medium/memory 1630, including circuitry 1621 for receiving, from a user equipment (UE) prior to a handover of the UE to a target base station, one or more first segments of a radio resource control (RRC) message, circuitry 1622 for transmitting, to the UE, feedback indicating the source base station successfully received one or more of the first segments, and code 1623 for transmitting, to the target base station, one or more of the first segments successfully received by the source base station.

Various components of communications device 1600 may provide means for performing the methods described herein, including with respect to FIG. 13.

In some examples, means for transmitting or sending (or means for outputting for transmission) may include the transceivers 232 and/or antenna(s) 234 of the base station 102 illustrated in FIG. 2 and/or transceiver 1608 and antenna 1610 of the communication device 1600 in FIG. 16.

In some examples, means for receiving (or means for obtaining) may include the transceivers 232 and/or antenna(s) 234 of the base station illustrated in FIG. 2 and/or transceiver 1608 and antenna 1610 of the communication device 1600 in FIG. 16.

In some examples, means for receiving and/or controlling may include various processing system components, such as: the one or more processors 1620 in FIG. 16, or aspects of the base station 102 depicted in FIG. 2, including receive processor 238, transmit processor 220, TX MIMO processor 230, and/or controller/processor 240 (including RRC Segmentation component 241).

Notably, FIG. 16 is an example, and many other examples and configurations of communication device 1600 are possible.

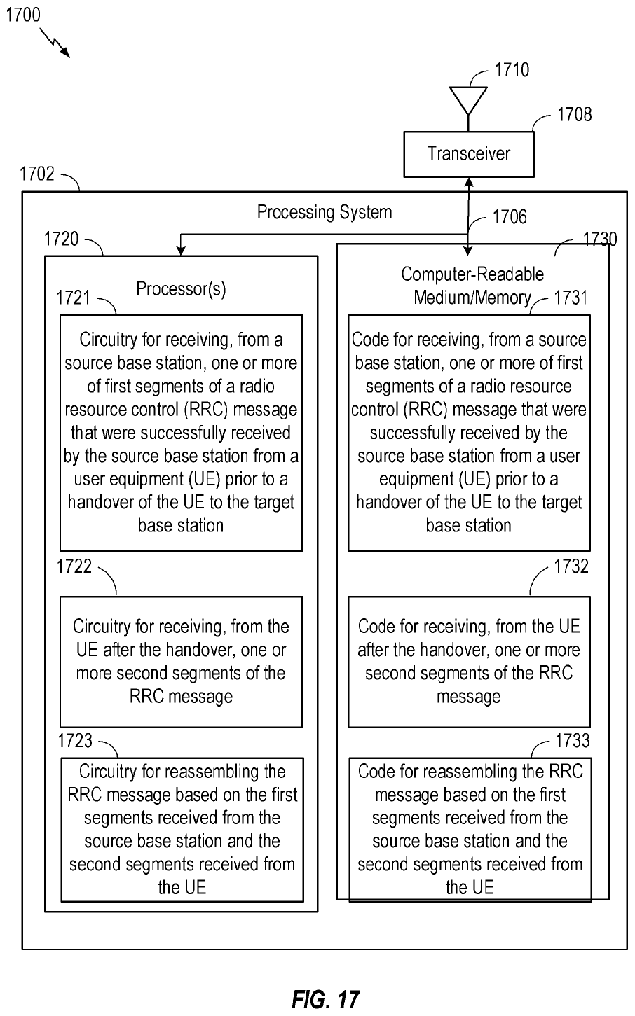

FIG. 17 depicts an example communications device 1700 that includes various components operable, configured, or adapted to perform operations for the techniques disclosed herein, such as the operations depicted and described with respect to FIG. 14. In some examples, communication device 1700 may be a base station 102 as described, for example with respect to FIGS. 1 and 2.

Communications device 1700 includes a processing system 1702 coupled to a transceiver 1708 (e.g., a transmitter and/or a receiver). Transceiver 1708 is configured to transmit (or send) and receive signals for the communications device 1700 via an antenna 1710, such as the various signals as described herein. Processing system 1702 may be configured to perform processing functions for communications device 1700, including processing signals received and/or to be transmitted by communications device 1700.

Processing system 1702 includes one or more processors 1720 coupled to a computer-readable medium/memory 1730 via a bus 1706. In certain aspects, computer-readable medium/memory 1730 is configured to store instructions (e.g., computer-executable code) that when executed by the one or more processors 1720, cause the one or more processors 1720 to perform the operations illustrated in FIG. 14, or other operations for performing the various techniques discussed herein.

In the depicted example, computer-readable medium/memory 1730 stores code 1731 for receiving, from a source base station, one or more of first segments of a radio resource control (RRC) message that were successfully received by the source base station from a user equipment (UE) prior to a handover of the UE to the target base station, code 1732 for receiving, from the UE after the handover, one or more second segments of the RRC message, and code 1733 for reassembling the RRC message based on the first segments received from the source base station and the second segments received from the UE.

In the depicted example, the one or more processors 1720 include circuitry configured to implement the code stored in the computer-readable medium/memory 1730, including circuitry 1721 for receiving, from a source base station, one or more of first segments of a radio resource control (RRC) message that were successfully received by the source base station from a user equipment (UE) prior to a handover of the UE to the target base station, circuitry 1722 for receiving, from the UE after the handover, one or more second segments of the RRC message, and code 1723 for reassembling the RRC message based on the first segments received from the source base station and the second segments received from the UE.

Various components of communications device 1700 may provide means for performing the methods described herein, including with respect to FIG. 14.

In some examples, means for transmitting or sending (or means for outputting for transmission) may include the transceivers 232 and/or antenna(s) 234 of the base station 102 illustrated in FIG. 2 and/or transceiver 1708 and antenna 1710 of the communication device 1700 in FIG. 17.

In some examples, means for receiving (or means for obtaining) may include the transceivers 232 and/or antenna(s) 234 of the base station illustrated in FIG. 2 and/or transceiver 1708 and antenna 1710 of the communication device 1700 in FIG. 17.

In some examples, means for receiving and/or controlling may include various processing system components, such as: the one or more processors 1720 in FIG. 17, or aspects of the base station 102 depicted in FIG. 2, including receive processor 238, transmit processor 220, TX MIMO processor 230, and/or controller/processor 240 (including RRC Segmentation component 241).

Notably, FIG. 17 is an example, and many other examples and configurations of communication device 1700 are possible.

### Example Clauses

Implementation examples are described in the following numbered clauses:

Clause 1: A method for wireless communications by a user equipment (UE), comprising: transmitting, to a source base station prior to a handover of the UE to a target base station, one or more first segments of a radio resource control (RRC) message; and transmitting, to the target base station after the handover, one or more second segments of the RRC message.

Clause 2: The method of Clause 1, wherein transmitting the second segments, comprises at least one of: re-transmitting one or more segments of the RRC message that were unsuccessfully transmitted to the source base station; or transmitting one or more segments of the RRC message that were not transmitted to the source base station.

Clause 3: The method of any one of Clauses 1-2, wherein the UE transmits the one or more second segments to the source base station via a Packet Data Convergence Protocol (PDCP) layer.

Clause 4: The method of any one of Clauses 1-3, further comprising: receiving, from the source base station, signaling indicating one or more of the first segments were not successfully received by the source base station, wherein the UE re-transmits, to the target base station, the one or more of the first segments were not successfully received by the source base station.

Clause 5: The method of any one of Clauses 1-4, further comprising: providing, in a PDCP layer to the source base station, an indication of a PDCP sequence number for a last segment of the RRC message.

Clause 6: The method of any one of Clauses 1-5, further comprising: receiving, from the source base station, signaling indicating one or more of the first segments were not successfully received by the source base station, wherein the UE transmits, to the target base station, all PDCP packets corresponding segments of the RRC message, if PDCP packets corresponding segments of the RRC message are not successfully received by the source base station.

Clause 7: The method of any one of Clauses 1-6, further comprising: buffering, in an RRC layer, RRC segments.

Clause 8: The method of Clause 7, further comprising: receiving, from the target base station or the source base station, signaling indicating one or more of the first segments that were successfully received by the source base station, wherein the UE transmits, to the target base station, segments of the RRC message that were not indicated by the signaling.

Clause 9: The method of Clause 8, wherein the signaling comprises an RRC status report.

Clause 10: The method of Clause 8, further comprising: providing, from a PDCP layer of the UE to an RRC layer of the UE, an indication of RRC segments successfully received by the source base station or the target base station; wherein the UE transmits, to the target base station, segments of the RRC message that were not successfully received by the source base station.

Clause 11: The method of Clause 8, wherein the UE transmits, to the target base station, all segments of the RRC message, if not all of the segments of the RRC message are successfully received by the source base station.

Clause 12: A method for wireless communications by a source base station, comprising: receiving, from a user equipment (UE) prior to a handover of the UE to a target base station, one or more first segments of a radio resource control (RRC) message; transmitting, to the UE, feedback indicating the source base station successfully received one or more of the first segments; and transmitting, to the target base station, one or more of the first segments successfully received by the source base station.

Clause 13: The method of Clause 12, wherein the source base station receives one or more of the first segments from the UE via a Packet Data Convergence Protocol (PDCP) layer.

Clause 14: The method of Clause 13, wherein the source base station transmits the one or more of the first segments successfully received by the source base station to the target base station as at least one of: one or more RRC layer segments in order; or one or more PDCP service data units (SDUs).

Clause 15: The method of Clause 13, wherein the source base station transmits the one or more of the first segments successfully received by the source base station to the target base station as: one or more RRC layer segments, regardless of order.

Clause 16: The method of any one of Clauses 12-15, further comprising: receiving, from the UE, via a Packet Data Convergence Protocol (PDCP) layer, an indication of PDCP sequence number for a last segment of the RRC message; determining one or more of RRC segments is missing, based on the indication; and transmitting one or more PDCP service data units (SDUs), with the successfully received first segments, to the target base station.

Clause 17: A method for wireless communications by a target base station, comprising: receiving, from a source base station, one or more of first segments of a radio resource control (RRC) message that were successfully received by the source base station from a user equipment (UE) prior to a handover of the UE to the target base station; receiving, from the UE after the handover, one or more second segments of the RRC message; and reassembling the RRC message based on a first segments received from the source base station and the second segments received from the UE.

Clause 18: The method of Clause 17, wherein the target base station receives the one or more of the first segments successfully received by the source base station as at least one of: one or more RRC layer segments in order; or one or more PDCP service data units (SDUs).

Clause 19: The method of any one of Clauses 17-18, wherein the target base station receives the one or more of the first segments successfully received by the source base station as: one or more RRC layer segments, regardless of order.

Clause 20: The method of any one of Clauses 17-19, wherein the target base station receives the one or more of the first segments successfully received by the source base station as: one or more PDCP service data units (SDUs).

Clause 21: An apparatus, comprising: a memory comprising executable instructions; one or more processors configured to execute the executable instructions and cause the apparatus to perform a method in accordance with any one of Clauses 1-20.

Clause 22: An apparatus, comprising means for performing a method in accordance with any one of Clauses 1-20.

Clause 23: A non-transitory computer-readable medium comprising executable instructions that, when executed by one or more processors of an apparatus, cause the apparatus to perform a method in accordance with any one of Clauses 1-20.

Clause 24: A computer program product embodied on a computer-readable storage medium comprising code for performing a method in accordance with any one of Clauses 1-20.

### Additional Wireless Communication Network Considerations

The techniques and methods described herein may be used for various wireless communications networks (or wireless wide area network (WWAN)) and radio access technologies (RATs). While aspects may be described herein using terminology commonly associated with 3G, 4G, and/or 5G (e.g., 5G new radio (NR)) wireless technologies, aspects of the present disclosure may likewise be applicable to other communication systems and standards not explicitly mentioned herein.

5G wireless communication networks may support various advanced wireless communication services, such as enhanced mobile broadband (eMBB), millimeter wave (mmWave), machine type communications (MTC), and/or mission critical targeting ultra-reliable, low-latency communications (URLLC). These services, and others, may include latency and reliability requirements.

Returning to FIG. 1, various aspects of the present disclosure may be performed within the example wireless communication network 100.

In 3GPP, the term “cell” can refer to a coverage area of a NodeB and/or a narrowband subsystem serving this coverage area, depending on the context in which the term is used. In NR systems, the term “cell” and BS, next generation NodeB (gNB or gNodeB), access point (AP), distributed unit (DU), carrier, or transmission reception point may be used interchangeably. A BS may provide communication coverage for a macro cell, a pico cell, a femto cell, and/or other types of cells.

A macro cell may generally cover a relatively large geographic area (e.g., several kilometers in radius) and may allow unrestricted access by UEs with service subscription. A pico cell may cover a relatively small geographic area (e.g., a sports stadium) and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG) and UEs for users in the home). A BS for a macro cell may be referred to as a macro BS. A BS for a pico cell may be referred to as a pico BS. A BS for a femto cell may be referred to as a femto BS, home BS, or a home NodeB.

Base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). Base stations 102 configured for 5G (e.g., 5G NR or Next Generation RAN (NG-RAN)) may interface with 5GC 190 through second backhaul links 184. Base stations 102 may communicate directly or indirectly (e.g., through the EPC 160 or 5GC 190) with each other over third backhaul links 134 (e.g., X2 interface). Third backhaul links 134 may generally be wired or wireless.

Small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. Small cell 102′, employing NR in an unlicensed frequency spectrum, may boost coverage to and/or increase capacity of the access network.

Some base stations, such as gNB 180 may operate in a traditional sub-6 GHz spectrum, in millimeter wave (mmWave) frequencies, and/or near mmWave frequencies in communication with the UE 104. When the gNB 180 operates in mmWave or near mm Wave frequencies, the gNB 180 may be referred to as an mmWave base station.

The communication links 120 between base stations 102 and, for example, UEs 104, may be through one or more carriers. For example, base stations 102 and UEs 104 may use spectrum up to Y MHz (e.g., 5, 10, 15, 20, 100, 400, and other MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Wireless communication network 100 further includes a Wi-Fi access point (AP) 150 in communication with Wi-Fi stations (STAs) 152 via communication links 154 in, for example, a 2.4 GHz and/or 5 GHz unlicensed frequency spectrum. When communicating in an unlicensed frequency spectrum, the STAs 152/AP 150 may perform a clear channel assessment (CCA) prior to communicating in order to determine whether the channel is available.

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, 4G (e.g., LTE), or 5G (e.g., NR), to name a few options.

EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to the IP Services 176, which may include, for example, the Internet, an intranet, an IP Multimedia Subsystem (IMS), a PS Streaming Service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and may be used to schedule MBMS transmissions. MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

5GC 190 may include an Access and Mobility Management Function (AMF) 192, other AMFs 193, a Session Management Function (SMF) 194, and a User Plane Function (UPF) 195. AMF 192 may be in communication with a Unified Data Management (UDM) 196.

AMF 192 is generally the control node that processes the signaling between UEs 104 and 5GC 190. Generally, AMF 192 provides QoS flow and session management.

All user Internet protocol (IP) packets are transferred through UPF 195, which is connected to the IP Services 197, and which provides UE IP address allocation as well as other functions for 5GC 190. IP Services 197 may include, for example, the Internet, an intranet, an IP Multimedia Subsystem (IMS), a PS Streaming Service, and/or other IP services.

Returning to FIG. 2, various example components of BS 102 and UE 104 (e.g., the wireless communication network 100 of FIG. 1) are depicted, which may be used to implement aspects of the present disclosure.

At BS 102, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), and others. The data may be for the physical downlink shared channel (PDSCH), in some examples.

A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

Processor 220 may process (e.g., encode and symbol map) the data and control information to obtain data symbols and control symbols, respectively. Transmit processor 220 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for OFDM) to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

At UE 104, antennas 252a-252r may receive the downlink signals from the BS 102 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM) to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 104 to a data sink 260, and provide decoded control information to a controller/processor 280.

On the uplink, at UE 104, transmit processor 264 may receive and process data (e.g., for the physical uplink shared channel (PUSCH)) from a data source 262 and control information (e.g., for the physical uplink control channel (PUCCH) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 102.

At BS 102, the uplink signals from UE 104 may be received by antennas 234a-t, processed by the demodulators in transceivers 232a-232t, detected by a MIMO detector 236 if applicable, and further processed by a receive processor 238 to obtain decoded data and control information sent by UE 104. Receive processor 238 may provide the decoded data to a data sink 239 and the decoded control information to the controller/processor 240.

Memories 242 and 282 may store data and program codes for BS 102 and UE 104, respectively.

Scheduler 244 may schedule UEs for data transmission on the downlink and/or uplink.

5G may utilize orthogonal frequency division multiplexing (OFDM) with a cyclic prefix (CP) on the uplink and downlink. 5G may also support half-duplex operation using time division duplexing (TDD). OFDM and single-carrier frequency division multiplexing (SC-FDM) partition the system bandwidth into multiple orthogonal subcarriers, which are also commonly referred to as tones and bins. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers in some examples. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, and others).

As above, FIGS. 3A-3D depict various example aspects of data structures for a wireless communication network, such as wireless communication network 100 of FIG. 1.

In various aspects, the 5G frame structure may be frequency division duplex (FDD), in which for a particular set of subcarriers (carrier system bandwidth), subframes within the set of subcarriers are dedicated for either DL or UL. 5G frame structures may also be time division duplex (TDD), in which for a particular set of subcarriers (carrier system bandwidth), subframes within the set of subcarriers are dedicated for both DL and UL. In the examples provided by FIGS. 3A and 3C, the 5G frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description below applies also to a 5G frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. In some examples, each slot may include 7 or 14 symbols, depending on the slot configuration.

For example, for slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission).

The number of slots within a subframe is based on the slot configuration and the numerology. For slot configuration 0, different numerologies (u) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 3A-3D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for a UE (e.g., UE 104 of FIGS. 1 and 2). The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., 104 of FIGS. 1 and 2) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Additional Considerations

The preceding description provides examples of defining user equipment (UE) capability for machine learning (ML) support across a network cell group in communication systems. The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The techniques described herein may be used for various wireless communication technologies, such as 5G (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, and others. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, and others. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

The various illustrative logical blocks, modules and circuits described in connection with the present disclosure may be implemented or performed with a general purpose processor, a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user equipment (see FIG. 1), a user interface (e.g., keypad, display, mouse, joystick, touchscreen, biometric sensor, proximity sensor, light emitting element, and others) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for wireless communications by a user equipment (UE), comprising:
transmitting, to a source base station prior to a handover of the UE to a target base station, one or more first segments of a radio resource control (RRC) message; and
transmitting, to the target base station after the handover, one or more second segments of the RRC message.

2. The method of claim 1, wherein transmitting the second segments, comprises at least one of:
re-transmitting one or more segments of the RRC message that were unsuccessfully transmitted to the source base station; or
transmitting one or more segments of the RRC message that were not transmitted to the source base station.

3. The method of claim 1, wherein the UE transmits the one or more second segments to the source base station via a Packet Data Convergence Protocol (PDCP) layer.

4. The method of claim 1, further comprising:
receiving, from the source base station, signaling indicating one or more of the first segments were not successfully received by the source base station,
wherein the UE re-transmits, to the target base station, the one or more of the first segments were not successfully received by the source base station.

5. The method of claim 1, further comprising:
providing, in a PDCP layer to the source base station, an indication of a PDCP sequence number for a last segment of the RRC message.

6. The method of claim 1, further comprising:
receiving, from the source base station, signaling indicating one or more of the first segments were not successfully received by the source base station,
wherein the UE transmits, to the target base station, all PDCP packets corresponding segments of the RRC message, if PDCP packets corresponding segments of the RRC message are not successfully received by the source base station.

7. The method of claim 1, further comprising:
buffering, in an RRC layer, RRC segments.

8. The method of claim 7, further comprising:
receiving, from the target base station or the source base station, signaling indicating one or more of the first segments that were successfully received by the source base station,
wherein the UE transmits, to the target base station, segments of the RRC message that were not indicated by the signaling.

9. The method of claim 8, wherein the signaling comprises an RRC status report.

10. The method of claim 8, further comprising:
providing, from a PDCP layer of the UE to an RRC layer of the UE, an indication of RRC segments successfully received by the source base station or the target base station, wherein the UE transmits, to the target base station, segments of the RRC message that were not successfully received by the source base station.

11. The method of claim 8, wherein the UE transmits, to the target base station, all segments of the RRC message, if not all of the segments of the RRC message are successfully received by the source base station.

12. A user equipment (UE) configured for wireless communication, comprising:
a memory comprising executable instructions; and
one or more processors configured to execute the executable instructions and cause the UE to:
transmit, to a source base station prior to a handover of the UE to a target base station, one or more first segments of a radio resource control (RRC) message; and
transmit, to the target base station after the handover, one or more second segments of the RRC message.

13. The UE of claim 12, wherein transmitting the second segments, comprises at least one of:
re-transmitting one or more segments of the RRC message that were unsuccessfully transmitted to the source base station; or
transmitting one or more segments of the RRC message that were not transmitted to the source base station.

14. The UE of claim 12, wherein the UE transmits the one or more second segments to the source base station via a Packet Data Convergence Protocol (PDCP) layer.

15. The UE of claim 12, wherein the one or more processors are further configured to execute the executable instructions and cause the UE to:
receive, from the source base station, signaling indicating one or more of the first segments were not successfully received by the source base station,
wherein the UE re-transmits, to the target base station, the one or more of the first segments were not successfully received by the source base station.

16. The UE of claim 12, wherein the one or more processors are further configured to execute the executable instructions and cause the UE to:
provide, in a PDCP layer to the source base station, an indication of a PDCP sequence number for a last segment of the RRC message.

17. The UE of claim 12, wherein the one or more processors are further configured to execute the executable instructions and cause the UE to:
receive, from the source base station, signaling indicating one or more of the first segments were not successfully received by the source base station,
wherein the UE transmits, to the target base station, all PDCP packets corresponding segments of the RRC message, if PDCP packets corresponding segments of the RRC message are not successfully received by the source base station.

18. The UE of claim 12, wherein the one or more processors are further configured to execute the executable instructions and cause the UE to:
buffer, in an RRC layer, RRC segments.

19. The UE of claim 18, wherein the one or more processors are further configured to execute the executable instructions and cause the UE to:
receive, from the target base station or the source base station, signaling indicating one or more of the first segments that were successfully received by the source base station,
wherein the UE transmits, to the target base station, segments of the RRC message that were not indicated by the signaling.

20. The UE of claim 19, wherein the signaling comprises an RRC status report.

21. The UE of claim 19, wherein the one or more processors are further configured to execute the executable instructions and cause the UE to:
provide, from a PDCP layer of the UE to an RRC layer of the UE, an indication of RRC segments successfully received by the source base station or the target base station, wherein the UE transmits, to the target base station, segments of the RRC message that were not successfully received by the source base station.

22. The UE of claim 19, wherein the UE transmits, to the target base station, all segments of the RRC message, if not all of the segments of the RRC message are successfully received by the source base station.

23. A method for wireless communications by a source base station, comprising:
receiving, from a user equipment (UE) prior to a handover of the UE to a target base station, one or more first segments of a radio resource control (RRC) message;
transmitting, to the UE, feedback indicating the source base station successfully received one or more of the first segments; and
transmitting, to the target base station, one or more of the first segments successfully received by the source base station.

24. The method of claim 23, wherein the source base station receives one or more of the first segments from the UE via a Packet Data Convergence Protocol (PDCP) layer.

25. The method of claim 24, wherein the source base station transmits the one or more of the first segments successfully received by the source base station to the target base station as at least one of:
one or more RRC layer segments in order; or
one or more PDCP service data units (SDUs).

26. The method of claim 24, wherein the source base station transmits the one or more of the first segments successfully received by the source base station to the target base station as:
one or more RRC layer segments, regardless of order.

27. The method of claim 23, further comprising:
receiving, from the UE, via a Packet Data Convergence Protocol (PDCP) layer, an indication of PDCP sequence number for a last segment of the RRC message;
determining one or more of RRC segments is missing, based on the indication; and
transmitting one or more PDCP service data units (SDUs), with the successfully received first segments, to the target base station.

28. A method for wireless communications by a target base station, comprising:
receiving, from a source base station, one or more of first segments of a radio resource control (RRC) message that were successfully received by the source base station from a user equipment (UE) prior to a handover of the UE to the target base station;
receiving, from the UE after the handover, one or more second segments of the RRC message; and
reassembling the RRC message based on a first segments received from the source base station and the second segments received from the UE.

29. The method of claim 28, wherein the target base station receives the one or more of the first segments successfully received by the source base station as at least one of:
one or more RRC layer segments in order; or
one or more PDCP service data units (SDUs).

30. The method of claim 28, wherein the target base station receives the one or more of the first segments successfully received by the source base station as:
one or more RRC layer segments, regardless of order.

31. The method of claim 28, wherein the target base station receives the one or more of the first segments successfully received by the source base station as:
one or more PDCP service data units (SDUs).

32. An apparatus for wireless communications by a source base station, comprising:
a memory comprising executable instructions; and
one or more processors configured to execute the executable instructions and cause the source base station to
receive, from a user equipment (UE) prior to a handover of the UE to a target base station, one or more first segments of a radio resource control (RRC) message;
transmit, to the UE, feedback indicating the source base station successfully received one or more of the first segments; and
transmit, to the target base station, one or more of the first segments successfully received by the source base station.

33. An apparatus for wireless communications by a target base station, comprising:
a memory comprising executable instructions; and
one or more processors configured to execute the executable instructions and cause the target base station to
receive, from a source base station, one or more of first segments of a radio resource control (RRC) message that were successfully received by the source base station from a user equipment (UE) prior to a handover of the UE to the target base station;
receive, from the UE after the handover, one or more second segments of the RRC message; and
reassemble the RRC message based on a first segments received from the source base station and the second segments received from the UE.
